(19) United States
(12) Patent Application Publication
(10) Pub. No.: US 2025/0289113 A1
(43) Pub. Date: Sep. 18, 2025

(54) APPARATUS

(71) Applicant: HONDA MOTOR CO., LTD., Tokyo (JP)

(72) Inventors: Ryuma Ujino, Wako-shi (JP); Takumi Inden, Wako-shi (JP); Akira Mizutani, Wako-shi (JP)

(21) Appl. No.: 18/961,520

(22) Filed: Nov. 27, 2024

(30) Foreign Application Priority Data
Mar. 12, 2024 (JP) 2024-038163

(51) Int. Cl. B25G 1/10; B25F 5/02

(52) U.S. Cl. CPC B25G 1/102; B25F 5/02

(57) ABSTRACT

An apparatus includes: a tool having a first fit portion; a grip device that includes a plurality of finger parts having a second fit portion and an actuator that drives the plurality of finger parts; and a movement device that moves the grip device, wherein at least one of the first fit portion and the second fit portion has a taper shape, and the first fit portion and the second fit portion fit each other when the actuator drives the plurality of finger parts such that the plurality of finger parts grip the tool.

### CROSS-REFERENCE TO RELATED APPLICATION

Priority is claimed on Japanese Patent Application No. 2024-038163, filed on Mar. 12, 2024, the contents of which are incorporated herein by reference.

### BACKGROUND

### Field of the Invention

The present invention relates to an apparatus.

### Background

An apparatus in which an operation is performed using a tool is known (for example, refer to Japanese Unexamined Patent Application, First Publication No. 2018-158405). Such an apparatus includes, for example, a tool, a grip device (for example, an end effector) that grips the tool, and a movement device (for example, a robot arm) for moving the grip device.

### SUMMARY

In the apparatus as described above, it is necessary to cause the grip device to grip the tool with high accuracy.

In order to realize such high-accuracy gripping, in the apparatus of the related art, there may be cases in which a multi-fingered multi-DOF (degree of freedom) hand is employed as the grip device, the hand grips the tool so as to wrap the tool, and thereby, the gripping is strengthened. Alternatively, there may be also cases in which by recognizing the position of a marker attached to the tool using a sensor, positioning between the hand and the grip device is performed, and the accuracy of the gripping is ensured.

However, the multi-fingered multi-DOF hand includes a large number of components, and costs of the apparatus may be increased. Further, the increase in the number of components may increase efforts for maintaining quality and reliability. Further, the configuration that uses the marker and the sensor may also increase the costs of the apparatus.

Further, there is also a disadvantage that the tool which the apparatus can handle is limited to a tool to which the marker can be attached.

An aspect of the present invention aims at providing an apparatus capable of gripping a tool with high accuracy with a simple structure.

An apparatus according to a first aspect of the present invention includes: a tool having a first fit portion; a grip device that includes a plurality of finger parts having a second fit portion and an actuator that drives the plurality of finger parts; and a movement device that moves the grip device, wherein at least one of the first fit portion and the second fit portion has a taper shape, and the first fit portion and the second fit portion fit each other when the actuator drives the plurality of finger parts such that the plurality of finger parts grip the tool.

A second aspect of the present invention is the apparatus according to the first aspect which may further include: a placement device on which the tool is placed, wherein the placement device may include: a base portion; a contact part that comes into contact with the tool when the tool is placed on the placement device; and an elastic connection portion that elastically connects the base portion to the contact part.

A third aspect of the present invention is the device according to the first aspect or the second aspect which may further include: a placement device on which the tool is placed, wherein the tool may have a third fit portion, the placement device may have a fourth fit portion, at least one of the third fit portion and the fourth fit portion may have a taper shape, and the third fit portion and the fourth fit portion may fit each other when the movement device moves the grip device such that the tool is placed on the placement device.

A fourth aspect of the present invention is the apparatus according to any one of the first to third aspects, wherein the first fit portion may have a recess shape, and the second fit portion may have a protrusion shape.

A fifth aspect of the present invention is the apparatus according to any one of the first to fourth aspects, wherein the tool may have a blade for cutting a cut target, and the blade may extend in a direction that is perpendicular to a direction in which the tool moves for cutting the cut target.

A sixth aspect of the present invention is the apparatus according to the fifth aspect, wherein the tool may have an assistance surface that is connected to one end of the blade, and the assistance surface may extend in a plane that intersects with the direction in which the blade extends.

A seventh aspect of the present invention is the device according to the fifth aspect or the sixth aspect, wherein the tool may include a guide portion that comes into contact with the cut target and guides the cut target to the blade.

According to the first to seventh aspects of the present invention, it is possible to provide the apparatus capable of gripping the tool with high accuracy with a simple structure.

### BRIEF DESCRIPTION OF THE DRAWINGS

FIG. 1 is a perspective view showing a tool and a grip device according to an embodiment of the present invention.

FIG. 2 is a view showing the tool according to the embodiment of the present invention.

FIG. 3 is a cross-sectional view along an A-A line shown in FIG. 1.

FIG. 4 is a cross-sectional view along a B-B line shown in FIG. 1.

FIG. 5 is a view showing an apparatus according to the embodiment of the present invention.

FIG. 6 is a view showing a tool of the related art.

FIG. 7 is a view showing a tool according to a modification example of the present invention.

### DESCRIPTION OF EMBODIMENTS

Hereinafter, an apparatus according to an embodiment of the present invention will be described with reference to the drawings.

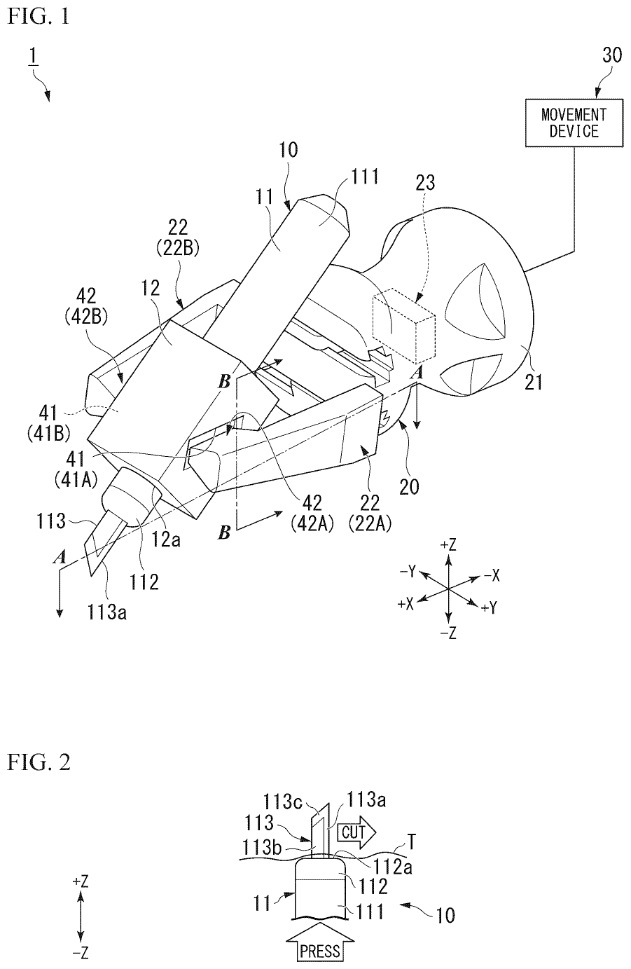

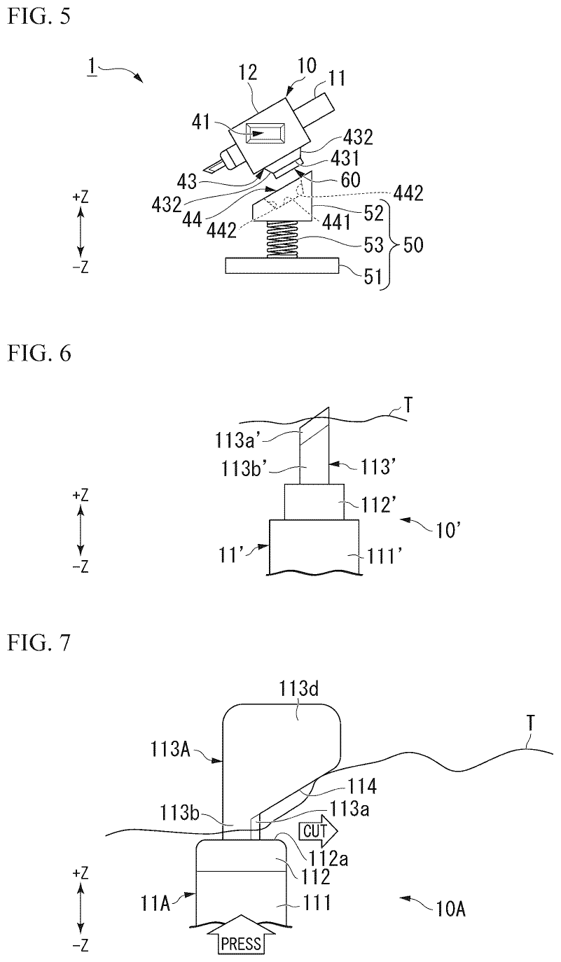

As shown in FIG. 1, a device 1 according to the present embodiment includes a tool 10, a grip device 20, and a movement device 30. The grip device 20 according to the present embodiment has a plurality (two in an example shown in the drawing) of finger parts 22. The apparatus 1 according to the present embodiment is an apparatus that performs an operation using the tool 10 by moving the grip device 20 in a state where the finger parts 22 grip the tool 10 by the movement device 30 or the like. Further, as shown in FIG. 5, the apparatus 1 according to the present embodiment further includes a placement device 50 on which the tool 10 is placed.

### (Direction Definition)

Hereinafter, a direction in which the two finger parts 22 are aligned is referred to as a first direction X (refer to FIG. 1). In the present embodiment, the first direction X intersects with a gravity direction Z. The gravity direction Z is a direction that is parallel to a gravity force and is also referred to as a vertical direction Z or an upward-downward direction Z. The first direction X may be a direction (that is, a horizontal direction) that is orthogonal to the gravity direction Z. A direction that intersects with both the first direction X and the gravity direction Z is referred to as a second direction Y. The second direction Y may be a direction (that is, a horizontal direction) that is orthogonal to the gravity direction Z. One direction in the first direction X is referred to as a forward direction (front side) and is represented by a +X direction. An opposite direction of the +X direction is referred to as a rearward direction (rear side) and is represented by a −X direction. One direction in the second direction Y is referred to as a rightward direction and is represented by a +Y direction. An opposite direction of the +Y direction is referred to as a leftward direction and is represented by a −Y direction. Further, an upward direction in the gravity direction Z is simply referred to as an “upward direction” and is represented by a +Z direction. A downward direction in the gravity direction Z is simply referred to as a “downward direction” and is represented by a −Z direction.

The tool 10 is a device used when the apparatus 1 performs an operation. As shown in FIG. 1, the tool 10 according to the present embodiment includes a tool main body 11 and an assistance instrument 12. In the present embodiment, the tool 10 (tool main body 11) is a cutter and has a blade 113a for cutting an object.

FIG. 2 is a view showing a state in which a cut target T having a thin cloth form is cut using the tool main body 11 (tool 10) according to the present embodiment. Specifically, in the example shown in the drawing, by inserting the blade 113a from below with respect to the cut target T and moving the tool main body 11 in a direction that intersects with the cut target T, cutting of the cut target T by the blade 113a is performed. Hereinafter, a direction in which the tool main body 11 moves (proceeds) for cutting the cut target T may be referred to as a cut direction. In the example shown in the drawing, the cut direction is to a rightward direction.

As shown in FIG. 2, the tool main body 11 according to the present embodiment includes a tool base portion 111, a holder portion 112, and a blade portion 113. The tool base portion 111 has a rod shape (also refer to FIG. 1). The holder portion 112 is provided on one end of the tool base portion 111. An outer diameter of the holder portion 112 may be the same as an outer diameter of the tool base portion 111. The holder portion 112 holds the blade portion 113. The holder portion 112 has an assistance surface 112a from which the blade portion 113 extends.

The blade portion 113 includes a blade 113a, a blade base section 113b, and an auxiliary blade 113c. Each of the blade 113a and the auxiliary blade 113c has a shape that is sharp to a degree capable of cutting the cut target T. The blade base section 113b extends from the holder portion 112. The blade base section 113b may have a configuration that cannot cut the cut target T. Hereinafter, a direction in which the blade base section 113b (blade portion 113) extends from the holder portion 112 may be referred to as an extension direction.

The blade 113a is provided on a side edge of the blade base section 113b. That is, the blade 113a is provided on an edge which the blade base section 113b has and which faces in a direction intersecting with the extension direction. The blade 113a extends in the extension direction. Thereby, the blade 113a extends in a direction that is perpendicular to a cut direction.

One end of the blade 113a is connected to the holder portion 112. Specifically, a base end portion (an end portion on the holder portion 112 side in the extension direction) of the blade 113a is connected to the assistance surface 112a. The assistance surface 112a extends in a plane that intersects with a direction (extension direction) in which the blade 113a extends. In other words, the blade 113a intersects with the assistance surface 112a. The assistance surface 112a may be a flat surface or may be a curved surface. The assistance surface 112a may be provided so as to surround the blade 113a (blade portion 113) when seen from the extension direction. When seen from the extension direction, an area of the assistance surface 112a may be larger than an area of the blade 113a (blade portion 113).

The auxiliary blade 113c is provided on a front end (an end on an opposite side of the holder portion 112 in the extension direction) of the blade base section 113b. The auxiliary blade 113c may have a configuration that is capable of cutting the cut target T. The auxiliary blade 113c may be used, for example, for making a cut in the cut target T when the blade portion 113 is inserted into the cut target T. One end of the auxiliary blade 113c may be connected to a front end (an end on an opposite side of the holder portion 112 in the extension direction) of the blade 113a.

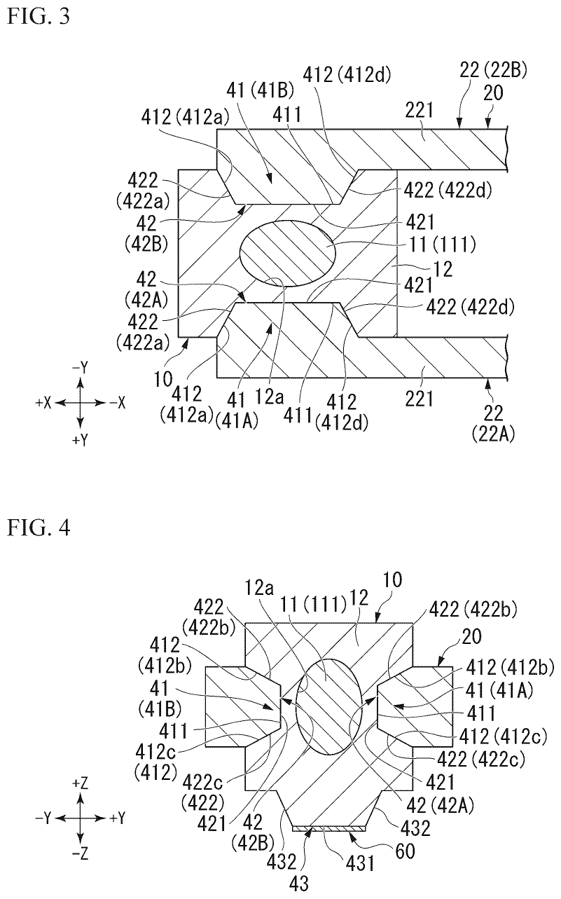

As shown in FIG. 1, the assistance instrument 12 is attached to the tool main body 11. Although the details will be described later, the assistance instrument 12 acts such that the grip device 20 easily grip the tool main body 11 (tool 10). The grip device 20 according to the present embodiment has an outer shape having a rectangular parallelepiped shape except for fit portions 41, 43 described later. As shown in FIG. 1, FIG. 3, and FIG. 4, the assistance instrument 12 according to the present embodiment includes an attachment hole 12a and a plurality (two in an example shown in the drawing) of first fit portions 41. As shown in FIG. 4 and FIG. 5, the assistance instrument 12 according to the present embodiment has a third fit portion 43.

The attachment hole 12a penetrates through the assistance instrument 12 (refer to FIG. 1). The shape of the attachment hole 12a corresponds to an outer shape of the tool main body 11 (refer to FIG. 3 and FIG. 4). As shown in FIG. 1, the tool main body 11 is attached (fixed) to the assistance instrument 12 in a state of being inserted in the attachment hole 12a. A fixation device (for example, a so-called set screw or the like) that exerts a force which fixes the tool main body 11 to the attachment hole 12a may be provided on the attachment hole 12a.

As shown in FIG. 1, FIG. 3, and FIG. 4, the first fit portion 41 is provided on a side surface of the assistance instrument 12. In other words, the first fit portion 41 is provided on a surface which the assistance instrument 12 has and which faces in the second direction Y. Hereinafter, the first fit portion 41 that is provided on a right side surface (+Y side surface) of the auxiliary tool 12 is referred to as a first right fit portion 41A, and the first fit portion 41 that is provided on a left side surface (−Y side surface) of the auxiliary tool 12 is referred to as a first left fit portion 41B.

As shown in FIG. 3 and FIG. 4, the first fit portion 41 according to the present embodiment has a recess shape that is recessed toward the inside (that is, the finger part 22 side) in the second direction Y from the side surface of the assistance instrument 12. Further, the first fit portion 41 according to the present embodiment has a taper shape in which an inner diameter decreases toward an inner side in the second direction Y. As shown in FIG. 3, the first fit portion 41 according to the present embodiment extends in the first direction X.

As shown in FIG. 3 and FIG. 4, the first fit portion 41 according to the present embodiment is surrounded by a gripped surface 411 and a plurality (four in the example shown in the drawing) of taper surfaces 412. Hereinafter, the four taper surfaces 412 are referred to as a first taper surface 412a, a second taper surface 412b, a third taper surface 412c, and a fourth taper surface 412d.

The gripped surface 411 is located at an inner end (front end) in the second direction Y of the first fit portion 41. The gripped surface 411 faces to the outside (that is, the finger part 22 side) in the second direction Y.

The gripped surface 411 is a surface that is gripped by the finger part 22 (grip surface 421). The gripped surface 411 may be a flat surface or may be a curved surface.

The plurality of taper surfaces 412 are located on a circumferential edge portion of the gripped surface 411 when seen from the second direction Y. As shown in FIG. 3, the first taper surface 412a is connected to a front side edge (+X side edge) of the gripped surface 411. The fourth taper surface 412d is connected to a rear side edge (−X side edge) of the gripped surface 411. As shown in FIG. 4, the second taper surface 412b is connected to an upper side edge (+Z side edge) of the gripped surface 411. The third taper surface 412c is connected to a lower side edge (−Z side edge) of the gripped surface 411. As shown in FIG. 3 and FIG. 4, each taper surface 412a, 412b, 412c, 412d is inclined relative to the second direction Y so as to approach to the gripped surface 411 toward the inside in the second direction Y. Each taper surface 412 may be a flat surface or may be a curved surface.

As shown in FIG. 4 and FIG. 5, the third fit portion 43 is provided on a lower surface of the assistance instrument 12. The third fit portion 43 according to the present embodiment has a protrusion shape that protrudes from the lower surface of the assistance instrument 12.

Further, the third fit portion 43 according to the present embodiment has a taper shape in which a cross-sectional area of a portion farther from the lower surface of the assistance instrument 12 is smaller.

The third fit portion 43 has a front end surface 431 and a plurality of taper surfaces 432. The plurality of taper surfaces 432 are located at a circumferential edge portion of the front end surface 431 when seen from a protrusion direction in which the front end surface 431 protrudes from the lower surface of the assistance instrument 12. Each taper surface 432 is connected to an edge of the front end surface 431. Each taper surface 432 is inclined relative to the protrusion direction such that a portion farther from the lower surface of the assistance instrument 12 is closer to the front end surface 431. Each of the front end surface 431 and the taper surface 432 may be a flat surface or may be a curved surface.

As shown in FIG. 5, an attraction portion 60 for attaching the tool 10 (third fit portion 43) to the placement device 50 (fourth fit portion 44) is provided on the front end surface 431 according to the present embodiment.

Specifically, the attraction portion 60 according to the present embodiment is a magnet for magnetically attaching the tool 10 to the placement device 50.

As shown in FIG. 1, the grip device 20 grips the tool 10. The grip device 20 according to the present embodiment includes a grip base portion 21, a plurality (two in an example shown in the drawing) of finger parts 22, and an actuator 23.

The grip base portion 21 is a portion that is connected to the movement device 30.

The finger part 22 extends forward from the grip base portion 21. The two finger parts 22 are arranged to be spaced apart from each other in the second direction Y. The two finger parts 22 have a configuration capable of moving closer to each other and moving apart from each other in the second direction Y. That is, the two finger parts 22 have a configuration that is openable and closable in the second direction Y. Hereinafter, the finger part 22 located on the right side (+Y side) is referred to as a right finger part 22A, and the finger part 22 located on the left side (−Y side) is referred to as a left finger part 22B.

As shown in FIG. 3, each finger part 22A, 22B has a finger base portion 221 that extends in the first direction X and a second fit portion 42 that is provided on a front end of the finger base portion 221. Hereinafter, the second fit portion 42 that is provided on the right finger part 22A is referred to as a second right fit portion 42A, and the second fit portion 42 that is provided on the left finger part 22B is referred to as a second left fit portion 42B.

As shown in FIG. 3 and FIG. 4, the second fit portion 42 according to the present embodiment has a protrusion shape that protrudes toward the inside (that is, the tool 10 side) in the second direction Y from the finger base portion 221. Further, the second fit portion 42 according to the present embodiment has a taper shape in which a cross-sectional area is smaller toward an inner side in the second direction Y.

The second fit portion 42 according to the present embodiment has a grip surface 421 and a plurality (four in an example shown in the drawing) of taper surfaces 422. Hereinafter, the four taper surfaces 422 are referred to as a first taper surface 422a, a second taper surface 422b, a third taper surface 422c, and a fourth taper surface 422d.

The grip surface 421 is located at an inner end (front end) in the second direction Y of the second fit portion 42.

The grip surface 421 faces inward in the second direction Y. The grip surface 421 is a surface that grips the tool 10 (gripped surface 411). The grip surface 421 may be a flat surface or may be a curved surface.

The plurality of taper surfaces 422 are located on a circumferential edge portion of the grip surface 421 when seen from the second direction Y.

As shown in FIG. 3, the first taper surface 422a is connected to a front side edge (+X side edge) of the grip surface 421. The fourth taper surface 422d is connected to a rear side edge (−X side edge) of the grip surface 421. As shown in FIG. 4, the second taper surface 422b is connected to an upper side edge (+Z side edge) of the grip surface 421. The third taper surface 422c is connected to a lower side edge (−Z side edge) of the grip surface 421. As shown in FIG. 3 and FIG. 4, each taper surface 422a, 422b, 422c, 422d is inclined relative to the second direction Y so as to approach to the grip surface 421 toward the inside in the second direction Y. Each taper surface 422 may be a flat surface or may be a curved surface.

As shown in FIG. 1, the actuator 23 is provided, for example, at the inside of the grip base portion 21.

The actuator 23 is connected to the two finger parts 22 and drives the two finger parts 22.

Specifically, the actuator 23 drives the opening and closing (described above) of the two finger parts 22. The actuator 23 drives the two finger parts 22, for example, such that the two finger parts 22 close and grip the tool 10. The actuator 23 may have, for example, a motor. The apparatus 1 may include a control portion (a CPU or the like) for operating the actuator 23.

The movement device 30 is a mechanism for moving the grip device 20. Although a detailed drawing is omitted, the movement device 30 may be a robot arm. The grip device 20 as an end effector may be attached to a front end of the movement device 30 which is the robot arm. However, as long as the grip device 20 is movable, the configuration of the movement device 30 can be changed as appropriate. The apparatus 1 may include a control portion for operating the movement device 30. The actuator 23 and the movement device 30 may be operated by the same control portion or may be operated by separate control portions.

The placement device 50 is a mechanism on which the tool 10 is placed (refer to FIG. 5). As shown in FIG. 5, the placement device 50 according to the present embodiment has a placement base portion 51 (base portion), a contact part 52, and an elastic connection portion 53. The contact part 52 has the fourth fit portion 44.

The placement base portion 51 is a portion (member) that is fixed to a floor surface, a work table, or the like. The placement base portion 51 may be the floor surface, the work table, or the like.

The contact part 52 is a portion (member) that comes into contact with the tool 10 when the tool 10 is placed on the placement device 50. A lower surface of the contact part 52 is connected to the placement base portion 51 via the elastic connection portion 53.

The elastic connection portion 53 elastically connects the placement base portion 51 to the contact part 52. Thereby, the contact part 52 has a configuration that is elastically displaceable three-dimensionally (that is, in three directions of the first direction X, the second direction Y, and the gravity direction Z) with respect to the placement base portion 51. The elastic connection portion 53 may be, for example, a spring. However, as long as the placement base portion 51 and the contact part 52 can be elastically connected to each other, the configuration of the contact part 52 can be changed as appropriate.

The fourth fit portion 44 is provided on an upper surface of the contact part 52. The fourth fit portion 44 according to the present embodiment has a recess shape that is recessed from the upper surface of the contact part 52. Further, the fourth fit portion 44 according to the present embodiment has a taper shape in which an inner diameter of a portion farther from the upper surface of the contact part 52 is smaller.

The fourth fit portion 44 has a bottom surface 441 and a plurality of taper surfaces 442. The plurality of taper surfaces 442 are located at a circumferential edge portion of the bottom surface 441 when seen from a recess direction in which the fourth fit portion 44 is recessed from the upper surface of the contact part 52. Each taper surface 442 is connected to an edge of the bottom surface 441. Each taper surface 442 is inclined relative to the recess direction such that a portion farther from the upper surface of the contact part 52 is closer to the bottom surface 441. Each of the bottom surface 441 and the taper surface 442 may be a flat surface or may be a curved surface. Next, an operation of the apparatus having the above-described configuration is described.

In the apparatus that performs an operation by using the tool, it is necessary to cause the grip device to grip the tool with high accuracy. In order to realize such high-accuracy gripping, in the apparatus of the related art, there may be cases in which a multi-fingered multi-DOF hand is employed as the grip device, the hand grips the tool so as to wrap the tool, and thereby, the gripping is strengthened. Alternatively, there may be also cases in which by recognizing the position of a marker attached to the tool using a sensor, positioning between the hand and the grip device is performed, and the accuracy of the gripping is ensured. However, in the configurations of the related art, there are problems that costs of the apparatus is increased, the grip accuracy becomes insufficient, or the like.

In order to solve the problems, in the apparatus 1 according to the present embodiment, the fit portions 41, 42 having a taper shape are provided on the tool 10 and the finger part 22, respectively (refer to FIG. 1, FIG. 3, and FIG. 4).

The first fit portion 41 and the second fit portion 42 fit each other when the actuator 23 drives the two finger parts 22 such that the two finger parts 22 grip the tool 10. That is, the first right fit portion 41A and the second right fit portion42A fit each other, and the first left fit portion 41B and the second left fit portion 42B fit each other. Hereinafter, the details are specifically described.

For example, a case is considered in which, when the finger part 22 is to grip the tool 10, the grip surface 421 of the finger part 22 is displaced forward (+X side) from the gripped surface 411 of the tool 10 (also refer to FIG. 3). In such a state, when the finger part 22 is closed, the first taper surfaces 412a, 422a that are provided on the fit portions 41, 42 come into slide contact with each other. At this time, the finger part 22 and the tool 10 relatively move in the X direction toward a position (hereinafter, referred to as a grip position) where the gripped surface 411 and the grip surface 421 are in contact with each other by a drag force that acts between the first taper surfaces 412a, 422a. That is, the first taper surfaces 412a, 422a slide relative to each other, and thereby, the relative position between the finger part 22 and the tool 10 is guided to the grip position.

Similarly, when the grip surface 421 is displaced rearward (−X side) relative to the gripped surface 411, the fourth taper surfaces 412d, 422d slide relative to each other, and thereby, the relative position between the finger part 22 and the tool 10 is guided to the grip position. Further, when the grip surface 421 is displaced in the gravity direction Z relative to the gripped surface 411, the second taper surfaces 412b, 422b or the third taper surfaces 412c, 422c slide relative to each other, and thereby, the relative position between the finger part 22 and the tool 10 is guided to the grip position (also refer to FIG. 4).

Thereby, without performing a recognition process or the like using a sensor or the like, it is possible to cause the finger part 22 to grip the tool 10 with high accuracy by a simple mechanical structure of the fit portions 41, 42.

In the grip position described above (that is, a state where the fit portions 41, 42 fit each other), the gripped surface 411 and the grip surface 421 may be in surface contact with each other. Similarly, in the grip position, the taper surfaces 412, 422 may be in surface contact with each other. That is, the first taper surfaces 412a, 422a may be in surface contact with each other, the second taper surfaces 412b, 422b may be in surface contact with each other, the third taper surfaces 412c, 422c may be in surface contact with each other, and the fourth taper surfaces 412d, 422d may be in surface contact with each other. According to this configuration, when the finger part 22 grips the tool 10, it is possible to prevent the position displacement between the finger part 22 and the tool 10. That is, it is possible to enhance the stability of the gripping of the tool 10 by the finger part 22.

Further, the apparatus 1 according to the present embodiment further includes the placement device 50 on which the tool 10 is placed (refer to FIG. 5). Thereby, by the movement device 30 moves the grip device 20 that grips the tool 10 to the vicinity of the placement device 50, then the actuator 23 opens the finger part 22 to release the gripping of the tool 10, and thereby, the tool 10 can be placed on the placement device 50. Accordingly, for example, when the tool 10 is not used, the tool 10 can be stored in the placement device 50.

Further, the fit portions 43, 44 having a taper shape are provided on the tool 10 and the placement device 50, respectively. Then, the third fit portion 43 and the fourth fit portion 44 fit each other when the movement device 30 moves the grip device 20 such that the tool 10 is placed on the placement device 50. Hereinafter, the details are specifically described.

For example, a case is considered in which, when the tool 10 is to be placed on the placement device 50, the front end surface 431 of the tool 10 is displaced in a horizontal direction relative to the bottom surface 441 of the placement device 50. In such a state, when the movement device 30 moves the grip device 20 downward, the taper surfaces 432, 442 that are provided on the fit portions 43, 44 come into slide contact with each other. At this time, the contact part 52 and the tool 10 relatively move toward a position (hereinafter, referred to as a placement position) where the front end surface 431 and the bottom surface 441 are in contact with each other via the attraction portion 60 by a drag force that acts between the taper surfaces 432, 442.

That is, the taper surfaces 432, 442 slide relative to each other, and thereby, the relative position between the contact part 52 and the tool 10 is guided to the placement position. Specifically, in the present embodiment, since the contact part 52 is connected to the placement base portion 51 via the elastic connection portion 53, the contact part 52 is elastically displaced in response to the drag force described above. Thereby, the relative movement described above is realized. After the relative position between the contact part 52 and the tool 10 is guided to the placement position, the actuator 23 opens the finger part 22 and releases the gripping of the tool 10, and thereby, the tool 10 is placed on the placement position. In this way, in the present embodiment, since the relative position between the contact part 52 and the tool 10 is guided to the placement position, the tool 10 can be easily placed on the placement device 50 without performing a recognition process or the like using a sensor or the like.

Here, the fit portions 43, 44 also have a role of fitting each other and thereby preventing the tool 10 placed on the placement device 50 from falling off from the placement device 50. Further, in the present embodiment, since the attraction portion 60 for attaching the tool 10 (third fit portion 43) to the placement device 50 (fourth fit portion 44) is provided on the front end surface 431, it is possible to further reliably prevent the falling.

When the tool 10 placed on the placement device 50 is used again, the tool 10 may be picked up from the placement device 50 by causing the finger part 22 to grip the tool 10 again and further moving the grip device 20 upward by the movement device 30.

When a force by which the movement device 30 picks up (separates) the tool 10 from the placement device 50 exceeds an attraction force by the attraction portion 60, the tool 10 is separated from the placement device 50.

When the attraction force of the attraction portion 60 is strong to a degree capable of holding the tool 10 to the placement device 50 without the fit portions 43, 44 or the like, the fit portions 43, 44 may not be provided on the tool 10 and the placement device 50. Even in this case, by the elastic displacement of the contact part 52, the attraction force of the attraction portion 60, and the like, the tool 10 can be placed on the placement device 50 even when the position between the placement device 50 and the tool 10 is displaced.

Further, in the tool 10 (cutter) according to the present embodiment, the blade 113a extends in a direction that is perpendicular to a direction (cut direction) in which the tool 10 moves for cutting the cut target T (refer to FIG. 2). Thereby, when cutting the cut target T by using the tool 10, it is possible to reduce the difficulty of the positioning of the tool 10 using the movement device 30. Hereinafter, the details are specifically described.

FIG. 6 is a view showing a state in which a cut target T having a thin cloth form is cut using a tool 10′ (tool main body 11′) of the related art. As shown in FIG. 6, the tool main body 11′ has a tool base portion 111′, a holder portion 112′, and a blade portion 113′. The blade portion 113′ has a blade 113a′ and a blade base section 113b′.

In the tool 10′ of the related art, the blade 113a′ is provided on a front end of the blade base section 113b′. Further, a direction in which the blade 113a′ extends is not orthogonal to the cut direction (the direction in which the cut target T extends).

In order to cut the cut target T using such a tool 10′, it is necessary for the blade portion 113′ to be always in contact with the cut target T during cutting. Accordingly, when the tool 10′ is operated by the movement device such as the robot arm, it is necessary to continue the positioning of the tool 10′ in a direction that is perpendicular to the cut target T so as to maintain a state where the blade portion 113′ is in contact with the cut target T. However, the direction in which the blade 113a′ extends is not orthogonal to the cut direction. Therefore, in the direction that is perpendicular to the cut direction, the position of the tool 10′ where the blade portion 113′ and the cut target T are in contact with each other is limited to a narrow region. Accordingly, such positioning may be difficult.

With respect to this problem, in the tool 10 according to the present embodiment, the blade 113a extends in a direction that is perpendicular to the cut direction (refer to FIG. 2). Thereby, in the direction that is perpendicular to the cut direction, the range of the position of the tool 10 where the blade 113a and the cut target T are in contact with each other can be enlarged as compared with the related art. Accordingly, it is possible to reduce the difficulty of positioning of the tool 10 in the direction that is perpendicular to the cut target T. Specifically, in the tool 10 according to the present embodiment, an assistance surface 112a that intersects with the extension direction of the blade 113a is provided on one end of the blade 113a. In other words, the blade 113a extends to the assistance surface 112a. Thereby, only by moving the tool 10 such that the assistance surface 112a is pressed to the cut target T, it is possible to perform the positioning between the cut target T and the tool 10 in the direction that is perpendicular to the cut direction. Then, by controlling the position of the tool 10 in the cut direction while pressing the assistance surface 112a to the cut target T, it is possible to perform the cutting of the cut target T. The circumferential edge portion of the assistance surface 112a may be chamfered in order to prevent the cut target T from being damaged. Further, the apparatus 1 may have a detection means which detects that the assistance surface 112a is in contact with the cut target T.

The above embodiment is described using an example in which the tool 10 is a cutter; however, the type of the tool 10 can be changed as appropriate. Further, the apparatus 1 may include a plurality of tools 10 having different shapes from each other. For example, the shapes (and applications) of the tool main bodies 11 of the plurality of tools 10 may be different from each other. A plurality of assistance instruments 12 corresponding to the plurality of tool main bodies 11 in a one-to-one relationship may be prepared. Here, the shape of the attachment hole 12a may be different among the plurality of assistance instruments depending on the outer shape of the corresponding tool main body 11. On the other hand, the shape of the first fit portion 41 that is provided on an outer circumferential surface of the assistance instrument 12 may be common among the plurality of assistance instruments 12. According to this configuration, a plurality of tools 10 (tool main bodies 11) having different shapes from each other can be gripped by a single grip device 20 without replacing the finger part 22 or the like. Further, the shape of the third fit portion 43 that is provided on an outer circumferential surface of the assistance instrument 12 may be common among the plurality of assistance instruments 12.

As described above, the apparatus 1 according to present embodiment includes: the tool 10 having the first fit portion 41; the grip device 20 that includes the two finger parts 22 having the second fit portion 42 and the actuator 23 that drives the two finger parts 22; and the movement device 30 that moves the grip device 20, wherein each of the first fit portion 41 and the second fit portion 42 has a taper shape, and the first fit portion 41 and second fit portion 42 fit each other when the actuator 23 drives the two finger parts 22 such that the two finger parts 22 grip the tool 10. According to this configuration, it is possible to provide an apparatus capable of gripping the tool 10 with high accuracy with a simple structure.

Further, the apparatus 1 according to the present embodiment further includes: the placement device 50 on which the tool 10 is placed, wherein the placement device 50 includes: the placement base portion 51 (base portion); the contact part 52 that comes into contact with the tool 10 when the tool 10 is placed on the placement device 50; and the elastic connection portion 53 that elastically connects the placement base portion 51 to the contact part 52. According to this configuration, the tool 10 is easily placed on the placement device 50.

Further, the tool 10 has the third fit portion 43, the placement device 50 has the fourth fit portion 44, each of the third fit portion 43 and the fourth fit portion 44 has a taper shape, and the third fit portion 43 and the fourth fit portion 44 fit each other when the movement device 30 moves the grip device 20 such that the tool 10 is placed on the placement device 50. According to this configuration, the tool 10 is easily placed on the placement device 50.

Further, the tool 10 has the blade 113a for cutting the cut target T, and the blade 113a extends in a direction that is perpendicular to a direction (cut direction) in which the tool 10 moves for cutting the cut target T. According to this configuration, it is possible to reduce the difficulty of the positioning of the tool 10 in the direction that is perpendicular to the cut direction.

Further, the tool 10 has the assistance surface 112a that is connected to one end of the blade 113a, and the assistance surface 112a extends in a plane that intersects with the direction in which the blade 113a extends. According to this configuration, it is possible to further reduce the difficulty of the positioning of the tool 10 in the direction that is perpendicular to the cut direction. More specifically, by moving the tool 10 such that the assistance surface 112a is pressed to the cut target T, it is possible to easily perform the positioning between the cut target T and the tool 10 in the direction (press direction) that is perpendicular to the cut direction.

The technical scope of the present invention is not limited to the embodiment described above, and various changes can be made without departing from the scope of the present invention.

FIG. 7 is a view showing a tool 10A according to a modification example of the present invention. The configuration of the tool 10A according to the present modification example is basically similar to the configuration of the tool 10 according to the embodiment described above. Therefore, similar configurations are denoted by the same reference numeral, descriptions thereof are omitted, and only different points are described.

The tool 10A (tool main body 11A) according to the present modification example has a blade portion 113A that is different from the blade portion 113 in the embodiment described above. The blade portion 113A according to the present modification example has a guide portion 113d in addition to the blade 113a and the blade base section 113b.

The guide portion 113d has an inclination surface 114 that is connected to a front end of the blade 113a. The inclination surface 114 is located at a forward position (right side in the drawing) in the cut direction when seen from the blade 113a. The inclination surface 114 is inclined relative to the cut direction such that the inclination surface 114 approaches to the blade 113a in the extension direction (described above) as the inclination surface 114 approaches the blade 113a in the cut direction. The inclination surface 114 comes into contact with the cut target T when the tool 10 proceeds in the cut direction. Then, the cut target T is guided to the blade 113a in the extension direction by the drag force exerted by the inclination surface 114 on the cut target T.

As described above, the tool 10A according to the present modification example has the guide portion 113d that comes into contact with the cut target T and guides the cut target T to the blade 113a. According to this configuration, it is possible to further reduce the difficulty of the positioning of the tool 10A in the extension direction of the blade 113a.

Although a detailed drawing is omitted, the grip device 20 may have three finger parts 22. In this case, the three finger parts 22 may be have a configuration that opens and closes radially about the tool 10. That is, the three finger parts 22 may grip the tool 10 so as to surround the tool 10 from three directions. Three second fit portions 42 may be provided so as to correspond to the three finger parts 22. Further, three first fit portions 41 corresponding to the three second fit portions 42 may be provided on the tool 10. The grip device 20 may have four or more finger parts 22.

Further, the above embodiment is described using an example in which the first fit portion 41 has a recess shape, and the second fit portion 42 has a protrusion shape; however, the first fit portion 41 may have a protrusion shape, and the second fit portion 42 may have a recess shape. That is, it is sufficient that one of the first fit portion 41 and the second fit portion 42 has a protrusion shape, and another of the first fit portion 41 and the second fit portion 42 has a recess shape. However, in the apparatus 1 in which it is assumed that the finger part 22 (first fit portion 41) grips an object other than the tool 10, a configuration in which the first fit portion 41 has a protrusion shape is preferable. Similarly, the third fit portion 43 may have a recess shape, and the fourth fit portion 44 may have a protrusion shape. That is, it is sufficient that one of the third fit portion 43 and the fourth fit portion 44 has a protrusion shape, and another of the third fit portion 43 and the fourth fit portion 44 has a recess shape.

Further, the above embodiment is described using an example in which both fit portions 41, 42 have a taper shape; however, one of the fit portions 41, 42 may not have a taper shape (also refer to FIG. 3 and FIG. 4).

That is, at least one of the first fit portion 41 and the second fit portion 42 may have a taper shape. For example, the second fit portion 42 may have a rectangular parallelepiped shape. That is, the taper surface 422 that is inclined relative to the second direction Y may be replaced by a parallel plane (not shown) that is parallel to the second direction Y. Even in such a configuration, a circumferential edge portion of the grip surface 421 comes into slide contact with the taper surface 412 of the first fit portion 41, and thereby, it is possible to guide the relative position between the finger part 22 and the tool 10 to the grip position similarly to the embodiment described above. Similarly, one of the fit portions 43, 44 may not have a taper shape. That is, at least one of the third fit portion 43 and the fourth fit portion 44 may have a taper shape.

Further, in an example shown in FIG. 1 and the like, when the grip device 20 grips the tool 10, the tool 10 (tool main body 11) is inclined with relative to the gravity direction Z and the horizontal direction; however, the direction of the tool 10 is not limited thereto and can be changed as appropriate.

Further, the above embodiment is described using an example in which the attraction portion 60 is a magnet; however, the type of the attraction portion 60 can be changed as appropriate as long as the tool 10 can be attached to the placement device 50.

For example, a mechanism (an air chuck or the like) for attaching the tool 10 to the placement device 50 by using an air pressure may be employed as the attraction portion 60. Further, the attraction portion 60 may be provided on a portion other than the front end surface 431. The apparatus 1 may not include the attraction portion 60.

The components in the embodiment described above can be appropriately replaced with well-known components without departing from the scope of the present invention, and the embodiment and the modification example described above may be appropriately combined.

What is claimed is:

1. An apparatus comprising:
a tool having a first fit portion;
a grip device that includes a plurality of finger parts having a second fit portion and an actuator that drives the plurality of finger parts; and
a movement device that moves the grip device,
wherein at least one of the first fit portion and the second fit portion has a taper shape, and
the first fit portion and the second fit portion fit each other when the actuator drives the plurality of finger parts such that the plurality of finger parts grip the tool.

2. The apparatus according to claim 1, further comprising:
a placement device on which the tool is placed,
wherein the placement device includes: a base portion; a contact part that comes into contact with the tool when the tool is placed on the placement device; and an elastic connection portion that elastically connects the base portion to the contact part.

3. The apparatus according to claim 1, further comprising:
a placement device on which the tool is placed,
wherein the tool has a third fit portion,
the placement device has a fourth fit portion,
at least one of the third fit portion and the fourth fit portion has a taper shape, and
the third fit portion and the fourth fit portion fit each other when the movement device moves the grip device such that the tool is placed on the placement device.

4. The apparatus according to claim 1,
wherein the first fit portion has a recess shape, and
the second fit portion has a protrusion shape.

5. The apparatus according to claim 1,
wherein the tool has a blade for cutting a cut target, and
the blade extends in a direction that is perpendicular to a direction in which the tool moves for cutting the cut target.

6. The apparatus according to claim 5,
wherein the tool has an assistance surface that is connected to one end of the blade, and
the assistance surface extends in a plane that intersects with the direction in which the blade extends.

7. The apparatus according to claim 5,
wherein the tool includes a guide portion that comes into contact with the cut target and guides the cut target to the blade.

8. The apparatus according to claim 2, further comprising:
a placement device on which the tool is placed,
wherein the tool has a third fit portion,
the placement device has a fourth fit portion,
at least one of the third fit portion and the fourth fit portion has a taper shape, and
the third fit portion and the fourth fit portion fit each other when the movement device moves the grip device such that the tool is placed on the placement device.

9. The apparatus according to claim 2,
wherein the first fit portion has a recess shape, and
the second fit portion has a protrusion shape.

10. The apparatus according to claim 2,
wherein the tool has a blade for cutting a cut target, and
the blade extends in a direction that is perpendicular to a direction in which the tool moves for cutting the cut target.

11. The apparatus according to claim 10,
wherein the tool has an assistance surface that is connected to one end of the blade, and
the assistance surface extends in a plane that intersects with the direction in which the blade extends.

12. The apparatus according to claim 10,
wherein the tool includes a guide portion that comes into contact with the cut target and guides the cut target to the blade.
